(19) United States
(12) Patent Application Publication
(10) Pub. No.: US 2008/0073095 A1
(43) Pub. Date: Mar. 27, 2008

(54) Vibration Damped Impact Tool with Pressure Air Feed Means

(75) Inventors: Stig Roland Henriksson, Nacka (SE); Olof Bertil Sigurd Ostenssn, Kalmar (SE)

Correspondence Address: FRISHAUF, HOLTZ, GOODMAN & CHICK, PC, 220 Fifth Avenue, 16TH Floor, NEW YORK, NY, 10001-7708, US

(73) Assignee: Atlas Copco Tools AB, Nacka (SE)

(21) Appl. No.: 11/631,825

(22) PCT Filed: Jul. 5, 2005
(86) PCT No.: PCT/SE05/01118

§ 371 Date: Jun. 20, 2007

(30) Foreign Application Priority Data
Jul. 5, 2004 (SE) 0401729-9

(51) Int. Cl. B25D 17/24

(52) U.S. Cl. 173/162.2

(57) ABSTRACT

A pneumatic impact tool comprises a housing having pressure air supply passage, and an impact mechanism movably supported in the housing and having a front opening for receiving a working implement and a hammer piston for delivering hammer blows to the working implement. The impact mechanism is supported in the housing by a pivot device in a point located between the forward and rear ends of the impact mechanism and allowing longitudinal and pivotal movements but preventing in the support point radial and rotational movements of the impact mechanism relative to the housing. A resilient membrane is located at a distance from the pivot device and is arranged to bias the impact mechanism to a neutral position relative to the housing while absorbing longitudinal as well as radial vibration movements of the impact mechanism. The membrane has at least one air feed passage connecting the air supply passage to the impact mechanism.

The invention relates to a vibration damped pneumatic impact tool which comprises a housing with at least one handle for manual support of the tool, and an impact mechanism which is movably supported in the housing for vibration damping purposes.

In this type of tool there is a problem to feed pressure air from the housing to the impact mechanism. In previous tools of this type a common way to accomplish such air feed is to provide the impact mechanism with a rear feed tube which extends co-axially into a pressure air chamber in the housing. See for instance U.S. Pat. No. 2,899,934. This arrangement, however, is limited to tools where the impact mechanism is linearly movable relative to the housing.

The main object of the invention is to provide a vibration damped impact tool where the impact mechanism is movable relative to the housing, and a pressure air feed means which is not restricted to linear movements of the impact mechanism.

Further characteristics and advantages of the invention will appear from the following specification and claims.

A preferred embodiment of the invention is below described in detail with reference to the accompanying drawing.

In the drawings

FIG. 1 shows a longitudinal section through a power tool according to one embodiment of the invention.

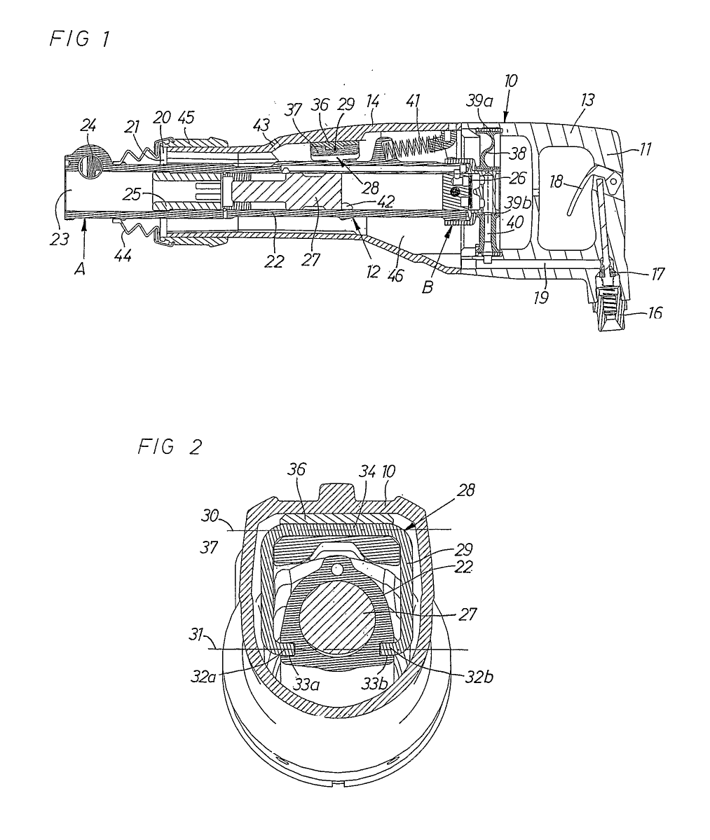

FIG. 2 shows a transverse section through the power tool in FIG. 1.

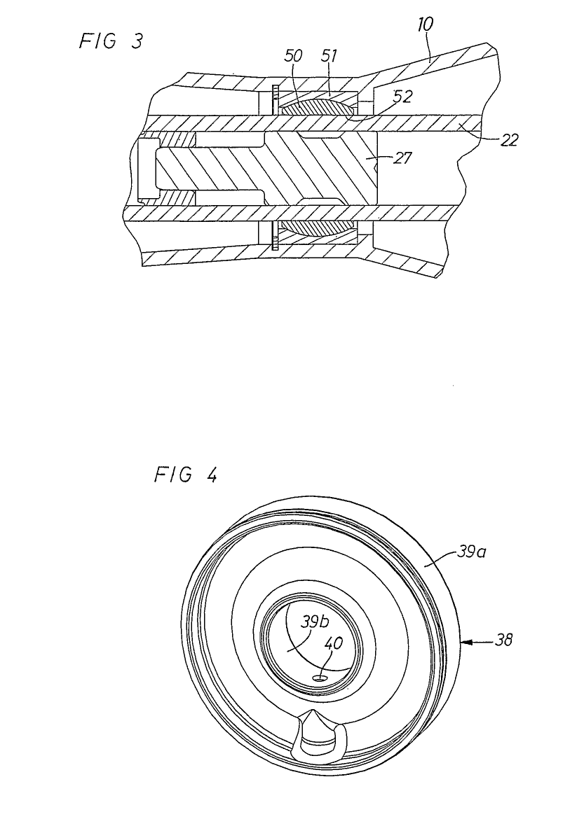

FIG. 3 shows a fractional view of a power tool according to an alternative embodiment of the invention.

FIG. 4 shows on a larger scale a perspective view of an elastic membrane included in a power tool according to the invention.

The impact tool illustrated in FIGS. 1 and 2 comprises a housing 10 with a rear handle 11, and a pneumatic impact mechanism 12 which has a forward end A and a rear end B is movably supported in the housing 10. The housing 10 comprises a rear part 13 made of a metal casting and a forward part 14 made of a somewhat resilient sound damping material like polyurethane. In the rear part 13 of the housing 10 there is located a connection 16 for a pressure air conduit, a throttle valve 17 operated by a lever 18, and a pressure air supply passage 19 communicating with the impact mechanism 12. The housing 10 has a closed rear end and an opening 20 at its forward end, and the forward end A of the impact mechanism 12 is arranged to extend out through the forward end opening 20 to receive the rear end of a working implement, for instance a chisel (not shown). The rear end B of the impact mechanism 12 is located in the closed end of the housing 10. The opening 20 is wide enough to permit a certain radial movement of the forward part of the cylinder 22.

The impact mechanism 12 comprises a cylinder 22 with an implement receiving opening 23 and a working implement retaining lock spindle 24 at its forward end A. Inside the cylinder 22 there is a working implement guide sleeve 25. At its rear end B the cylinder 22 has a distribution valve 26 to feed pressure air into the cylinder 22 to drive a hammer piston 27 in a reciprocating manner to accomplish repeated hammer blows on the working implement. The impact mechanism 12 is not described in further detail since it is of a conventional type and does not form a part of the invention. At a position between its forward end and its rear end the cylinder 22 is supported relative to the housing 10 by means of a pivot device 28 including a link 29. See FIG. 2. The link 29 is pivotal relative to the housing 10 and to the cylinder 22 via two parallel axes 30, 31, which means that the cylinder 22 is able to be pivoted as well as longitudinally displaced, whereas rotational and radial movements in the support point are substantially prevented. The link 29 is made of a bent wire having its ends 32a,b received in lateral openings 33a,b in the cylinder 22 extending co-axially with the axis 31. The mid section 34 of the link 29 is pivoted in a resilient block comprising a base member 36 and a cap 37 both secured to the housing 10 by threaded fasteners.

Due to the parallel axes arrangement of the link 29 pivotation of the cylinder 22 is possible in substantially one plane, but due to some weakness in the link 29 itself and the resilient block 36,37 some pivotal movements of the cylinder 22 in other planes would also be possible.

In order to bias the cylinder 22 into a neutral position in the housing 10, both lengthwise and sidewise, there is provided an annular resilient membrane 38 is mounted between the rear end of the cylinder 22 and the housing 10 such that an outer periphery 39a of the membrane 38 is supported against the housing 10 and an inner periphery 39b of the membrane 38 is supported against the cylinder 22. See FIG. 4. This membrane 38 is not only able to bias the cylinder 22 towards a neutral position in the housing 10 but will yield elastically to radial and longitudinal movements of the cylinder 22, thereby absorbing vibration movements of the cylinder 22 and protect the housing 10 and hence the operator from such vibrations. The membrane 38 is also formed with a radially extending air feed passage 40 for communicating pressure air from the air supply passage 19 in the housing 10 to the distribution valve 26 via the inner periphery 39b for driving the hammer piston 27 in the cylinder 22.

Moreover, there is provided a coil spring 41 between a the cylinder 22 and the housing 10 for transferring to the cylinder 22 and further to the working implement feed forces applied on the housing 10 via for instance the handle 11. The spring 41 will also absorb vibration movements in cylinder 22.

The cylinder 22 has exhaust openings 42 located inside the housing 10, and the housing 10 is provided with exhaust air outlet openings 43 to duct away exhaust air from the impact mechanism 12 during operation of the tool. In order to prevent exhaust air from leaving the housing 10 through the forward opening 20 there is fitted a bellow 44 bridging the gap between the cylinder 22 and the housing 10 while permitting radial as well as longitudinal movements of the cylinder 22. Because of the rear closed end of the housing 10 and the bellow 44 at the forward end of the housing 10 there is formed a sound damping chamber 46 inside the housing 10.

At the forward end of the housing 10 there is mounted an external sleeve 45 which has the double function as a grip element for the operator in horizontal working positions. The sleeve 45 is made of a heavy material like steel and is also utilized as a vibration reducing weight.

It is to be noted that the embodiments of the invention are not limited to the above described examples but can be varied within the scope of the claims. For instance the pivot device 28 could be designed otherwise. In FIG. 3, there is illustrated an alternatively designed pivot device which instead of a link comprises a universal joint with a spherical element 50 pivotally supported in a spherical socket portion 51 retained in the housing in the housing 10. The spherical element 50 has a through opening 52 for slidably guiding the cylinder 22 in a longitudinal direction. In this embodiment of the invention the cylinder 22 is able to pivot in any plane which is favourable in absorbing transverse vibration forces generated in the chisel and the cylinder 22. In this example rotational forces are transferred between the housing 10 and cylinder 22 by the membrane 38.

1. A pneumatic impact tool comprising:
a housing having a pressure air supply passage and at least one handle for manual support of the tool,
an impact mechanism supported in the housing to perform non-linear vibration absorbing movements, and
a resilient element provided between the impact mechanism and the housing to absorb vibration movements of the impact mechanism and to bias the impact mechanism towards a neutral position relative to the housing,
wherein said resilient element comprises an annular membrane having an outer periphery resting against the housing and an inner periphery resting against the impact mechanism, and
wherein said membrane comprises at least one air feed passage connecting the pressure air supply passage in the housing to the impact mechanism.

2. An impact tool according to claim 1, wherein said at least one air feed passage extends substantially radially through said membrane.

3. An impact tool according to claim 1, wherein said membrane is yieldable elastically both to longitudinal and radial movements of the impact mechanism relative to the housing.

4. An impact tool according to claim 2, wherein said membrane is yieldable elastically both to longitudinal and radial movements of the impact mechanism relative to the housing.
